(19) United States
(12) Patent Application Publication
(10) Pub. No.: US 2012/0191397 A1
(43) Pub. Date: Jul. 26, 2012

(54) Method and apparatus for monitoring motion of a body

(76) Inventor: Graham Paul Eatwell, Annapolis, MD (US)

(21) Appl. No.: 13/374,849

(22) Filed: Jan. 19, 2012

Related U.S. Application Data
(60) Provisional application No. 61/461,707, filed on Jan. 21, 2011.
(60) Provisional application No. 61/464,921, filed on Mar. 11, 2011.

(51) Int. Cl. G06F 19/00; G01P 21/00

(52) U.S. Cl. 702/94; 73/1.79

(57) ABSTRACT

A method and apparatus for monitoring motion of a rigid body, such as a head, in which a plurality of reference sensors are attached to a calibration structure, such as a helmet, and a plurality of body-mountable sensors are adapted for mounting on the rigid body. Once mounted, the positions and orientations of the body-mountable sensors may be unknown. In operation, a processing unit receives signals from the reference sensors and the body-mountable sensors and determines calibration parameters for the body-mountable sensors. The calibration parameters depend upon the sensitivity of the body-mountable sensors to linear, rotational and centripetal motions. These sensitivities, in turn, are dependent upon the positions and orientations of the body-mountable sensors. Body motion is determined from the body-mountable sensors using the calibration parameters.

### CROSS-REFERENCE TO RELATED APPLICATIONS

This application claims the benefit of U.S. Provisional Patent Application 61/461,707 filed Jan. 21, 2011, titled ‘Method and Apparatus for Monitoring Rigid Body Motion’, and U.S. Provisional Patent Application 61/464,921 filed Mar. 11, 2011 and titled ‘Method and Apparatus for Monitoring Head Accelerations’. These applications are hereby incorporated by reference herein.

### BACKGROUND

A variety of methods have been presented for monitoring or sensing motion of a rigid body. One group of techniques is concerned with determining the position of a body by time integration of acceleration and/or velocity measurements. These techniques may be used, for example, in spacecraft or aircraft navigation, or in healthcare or sports science applications to determine position of a limb, such as an arm or a leg, of a subject. Another group of techniques has application to impact detection and, in particular, to head impact measurement. In this application, the objective is to measure accelerations, since these are thought to relate to brain injury.

It is well known that motion of a rigid body is uniquely defined by six degrees of freedom—translation of an origin (a selected location) in three dimensions and rotation about an axis.

Prior techniques separate these measurements by sensing linear accelerations in directions that pass through the selected location (the origin). For example, prior sensing systems for head impact monitoring use accelerometers with one or more sensing axes substantially perpendicular to the local surface of the head. One approach, such as disclosed in U.S. Pat. No. 5,978,972, uses sensors mounted in a protective helmet, for sports or military applications. Another approach, disclosed in U.S. Pat. No. 6,941,952 uses accelerometers in a mouth piece. Other approaches provide an incomplete measure of motion (i.e. fewer than six degrees of freedom). Examples include U.S. Pat. No. 6,826,509, which uses helmet based sensors, and U.S. Pat. No. 7,552,031 and published application US 2009/0000377, which both use body mounted sensors.

Approaches that use sensors in a helmet are flawed because the helmet may rotate on the head, or even become displaced, during an impact. Similarly, a mouthpiece may become dislodged on impact.

Approaches that use an accelerometer embedded in a patch attached to the head are flawed because the position and orientation of the patch on the head is not known with sufficient accuracy. Accelerations are measured at the sensor position, rather than at the center of the head.

Yet another approach uses a tri-axial sensor mounted at the center of mass—this approach is clearly impractical for applications such as head impact monitoring, but has application in man-made structures such as vehicles or test dummies.

In many applications, it is desirable that the sensors are as small as possible. MEMS sensors are typically small and have low power consumption, so are well suited to this application. MEMS sensors are typically constructed in layers, so it is much easier to construct accelerometers having sensing axes in the plane of the device. A MEMS sensor with only in-plane sensing axes is therefore easier to construct and is likely to have a lower profile. Such a device mounted flat on a surface would measure acceleration tangential to the surface.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a system for monitoring head motion in accordance with some embodiments of the invention.

FIG. 2 is a flow chart of a method for calibrating head mounted sensors and monitoring head motion in accordance with certain embodiments of the invention.

FIG. 3 is a flow chart of a further method for calibrating head mounted sensors and monitoring head motion in accordance with certain embodiments of the invention.

FIG. 4 shows block diagrams of two example systems for determining rigid body motion from sensor signals in accordance with certain embodiments of the invention.

FIG. 5 is a block diagram of a system for calibrating head mounted sensors and monitoring head motion in accordance with certain embodiments of the invention.

FIG. 6 is a system for monitoring head motion in accordance with some embodiments of the invention.

FIG. 7 shows plots of reference sensor signals for a simulated head motion.

FIG. 8 shows corresponding plots of head sensor signals for the simulated head motion.

FIG. 9 shows the motion of the head as determined by head sensors that have been calibrated in accordance with some embodiments of the invention.

FIG. 10 is a block diagram of an example apparatus for sensing motion of a substantially rigid body, in accordance with some embodiments of the invention.

FIG. 11 is an example sensor configuration, in accordance with some embodiments of the invention.

FIG. 12 is an example of a sensing structure, in accordance with some embodiments of the invention.

FIG. 13 shows two example sensor configurations for sensing motion of a head, in accordance with some embodiments of the invention.

FIG. 14 is a further example of a sensing structure, in accordance with some embodiments of the invention.

FIG. 15 is a sectional view of the sensing structure shown in FIG. 14.

FIG. 16 is a still further example of a sensing structure, in accordance with some embodiments of the invention.

FIG. 17 is a sectional view of the sensing structure shown in FIG. 16.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to monitoring head accelerations. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may include the use of one or more conventional processors and unique stored program instructions that control the one or more processors to implement, in conjunction with certain non-processor circuits, some, most, or all of the functions of monitoring head accelerations described herein. The non-processor circuits may include, but are not limited to, a radio receiver, a radio transmitter, signal drivers, clock circuits, power source circuits, and user input devices. As such, these functions may be interpreted as a method to monitor head accelerations. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Prior approaches to measuring rigid body motion have used sensors that are located on a common rigid structure, such as a helmet or a mouthpiece. This enables the relative positions and orientations of the sensors to be determined in advance of head monitoring. However, a disadvantage of this approach is that the common rigid structure may not be coupled to the head during high level impacts.

Another prior approach uses a single head-mounted sensor, such as triaxial accelerometer, embedded in a stick-on patch or an ear plug. While this enables the relative positions and orientations of the individual sensing elements to be determined in advance of head monitoring, the position and/or orientation of the accelerometer relative to some fixed origin, such as the center of mass or center of geometry of the head, are not known in advance. In many applications, measurement of the sensor's orientation and position is not practical. In addition, such sensors may need to be disposable and inexpensive. The cost of calibrating such sensors for sensitivity may be significant.

The sensitivity of a sensor to rigid body motion is dependent not only on the sensitivity of the sensing element, but also on the position and orientation of the sensing element on the rigid body.

One aspect of the present invention relates a method for determining the sensitivity to rigid body motion of a sensor located on a first rigid body. This is achieved by determining a motion vector of the first rigid body at multiple sample times using a set of reference sensors, measuring the response of the body mounted sensor at the sample times, and estimating the sensitivity to rigid body motion of the sensor from the motion vector at the plurality of sample times and the response of the sensor at the plurality of sample times. This enables automatic, in-situ calibration of the sensors.

In one embodiment of the invention, the motion vector of the rigid body, denoted as m, comprises three components of a linear acceleration vector, a, three components of a rotational acceleration vector \dot{ω} and six components of a centripetal acceleration vector γ(ω) of the first rigid body, where γ(ω) is a non-linear function of the rotational speed vector ω of the first rigid body. The motion vector may be derived from measurements of linear acceleration, rotational acceleration and/or rotational velocity.

In general the motion vector comprises at least six components. These may be three components of a linear acceleration vector, a, and at least three components of rotation, the components of rotation being selected from the three components of a rotational acceleration vector \dot{ω} and three components of rotational velocity vector ω. Other components, such as the centripetal acceleration vector, may be derived from these.

The description below relates to an application in which head motion is to be monitored by locating head-mounted sensors at one or more locations on a head. The sensitivities of the head-mounted sensors to rigid body motion of the head are determined by comparing the signals from the head-mounted sensors to motion sensed by reference sensors in a helmet. For relatively small motions of the head, the helmet is well coupled to the head and experiences the same rigid body motions. For large motions, the helmet may become uncoupled from the head and the head motion is determined from the head-mounted sensors. It should be understood the invention has application in other areas where the motion of a rigid body is to be detected. For example, a first set of sensors (disposable or not) may be attached to a body to be measured at arbitrary locations. A substantially rigid calibration structure (equivalent to the helmet) may be attached, at least temporarily, and used to calibrate the first set of sensors. Once the sensitivities have been determined, i.e. once the sensors are calibrated, the calibration structure may be removed. The calibration structure/helmet, since it is reusable, may use higher quality sensors that are periodically recalibrated in a controlled setting.

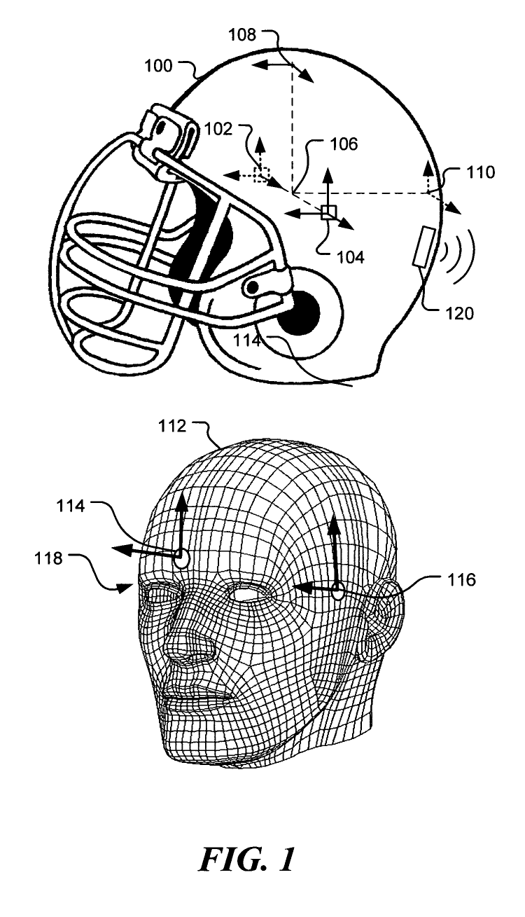

FIG. 1 is a diagrammatic representation of an embodiment of the invention as applied to head impact monitoring. Referring to FIG. 1, a helmet 100, such as a sports helmet or military helmet is provided with sensors to enable the linear and rotational motion of the helmet to be monitored. These sensors may be placed at precisely known positions. In the embodiment shown, tri-axial accelerometers are placed at positions 102 and 104 on opposite sides of an origin 106 (which may be designed to be close to the center of mass of the wearer's head), and two bi-axial accelerometers 108 and 110 are placed on the sagittal plane of the helmet, at 90° to each other relative to the origin 106. The bi-axial sensors are orientated substantially tangential to the wearer's head. More generally, 100 is a substantially rigid calibration structure that supports the reference sensors in fixed positions and orientations.

Other sensor arrangements and type may be used, using various combinations of sensor types, positions and orientations, provided that they are configured to enable the motion of the helmet to be determined. The sensors need not be orthogonal to one another. Sensor types include accelerometers, gyroscopes and/or rotational accelerometers, for example. Linear accelerometers are sensitive to both linear and rotational accelerations, while gyroscopes are sensitive to rotational velocity and rotational accelerometers are sensitive to rotational acceleration. For example, in one embodiment, three linear accelerometers and three rotation sensors are used. These sensors may be substantially co-located or placed at different locations.

In operation, removable sensors are placed on the wearer's head 112. In the embodiment shown, accelerometer 114 is placed on the forehead, accelerometer 116 on the side of the head (or behind an ear) and accelerometer 118 (not shown) on the opposite side of the head to sensor 116. For practical reasons, the placement of the sensors on the head is imprecise. In particular, the positions of the sensors relative to the center of mass of the head, or even relative to one another, are generally not known with sufficient accuracy to enable the head motions to be monitored accurately. The accelerometers may be bi-axial or tri-axial accelerometers or a combination single axis, bi-axial and/or tri-axial accelerometers. In addition, rotational sensors may be used.

When the helmet 100 is placed on the wearer's head 112, a calibration procedure is performed. To be effective, the helmet should fit snugly on the head. While the orientation of the helmet on the head is not known exactly, the position of the origin of the helmet relative to the center of mass of the head is fairly repeatable. Thus, the helmet provides a geometric reference frame. In general, the reference sensors are attached to a substantially rigid calibration structure such that the positions and orientations of the sensors relative to the structure are fixed and may be determined in advance.

Electronics module 120 may incorporate a telemetry unit that is operable to transmit signals or information derived from the signals to a remote location, such as the sidelines of a sports field, or a military information center, or an ad-hoc network. The electronics module 120 may incorporate a processor that computes the calibration parameters and head motion parameters. In one embodiment, the electronics module 120 also houses some or all of the reference sensors.

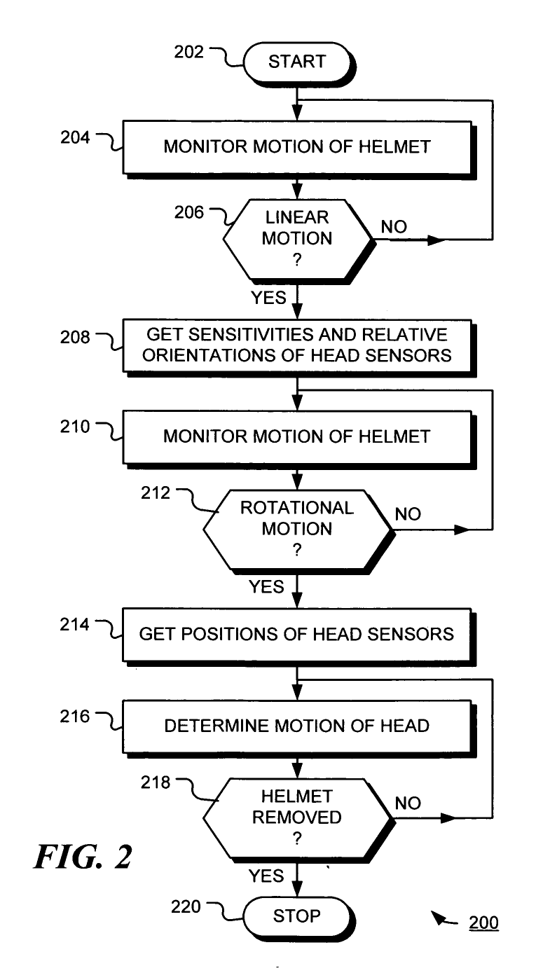

FIG. 2 is a flow chart 200 of a method of monitoring head motion in accordance with an embodiment of the invention. The process begins at block 202 when body-mountable sensors are mounted on the wearer's head and the helmet is placed on the wearer's head. At block 204 the rigid body motions, linear and rotational, of the helmet are determined from the signals from the reference sensors mounted on the helmet and the motion is monitored. If the helmet's rotational motion is below a threshold, as depicted by the positive branch from decision block 206, the sensor signals represent mainly linear accelerations, which are independent of sensor positions, and signals from helmet sensors and the head sensors may be used to determine the orientations and sensitivities of the head sensors relative to the helmet sensors at block 208. (Note that accelerations due to gravity constitute linear accelerations.) This is done by comparing sensor readings for a plurality of samples of the sensor signals. This enables future measurements to be referenced to a common frame of reference. In addition, it avoids the need for the head sensors to be calibrated before use, which is a significant cost saving, especially if the sensors are disposable. More generally, a substantially rigid calibration structure supporting the reference sensors is coupled to the body to be monitored, at least while the calibrations are made.

At block 210, the helmet motion is again monitored. If the rotational motion is above a threshold value, as depicted by the positive branch from decision block 212, the sensor positions are determined at block 214. It is assumed that the helmet and the head move together for small or moderate head movements, so the linear and rotational motion of the head is known. The sensitivity of a head sensor to motion of the head is determined by the linear and rotational motion of the head, the position and orientation of the sensor and the sensitivity of the sensing element. Thus, if the linear and rotational motions of the head are known, the sensitivity of the sensor to rigid body motion may be determined. This allows the head-mounted sensors to be calibrated in-situ.

If relative positions of the helmet origin and the head center of mass are known to any degree of accuracy, an offset may be applied to the head positions, so that measured motions are relative to the offset origin.

In practice, the center of mass of the wearer's head is not known precisely, so using the helmet origin at least provides a fairly repeatable reference point.

More importantly, the sensitivities of the head-mounted sensors, which depend upon their relative positions and orientations relative to the reference frame, may be accurately determined using the reference sensors.

During impact, the head sensors, or a combination of the head sensors and the helmet sensors, may be used to measure linear and rotational accelerations, as depicted by block 216.

Optionally, at decision block 218, a check is made to determine if the helmet has been removed from the wearer's head. In some applications, such as sports, this may be an indication that play has ended and monitoring is no longer required, as depicted by the positive branch from decision block 218, and the process terminates at block 220. In one embodiment, the head sensors may continue monitoring head motion and saving the results to memory or transmitting the results to another location (such as a belt pack recorder, or a remote recorder).

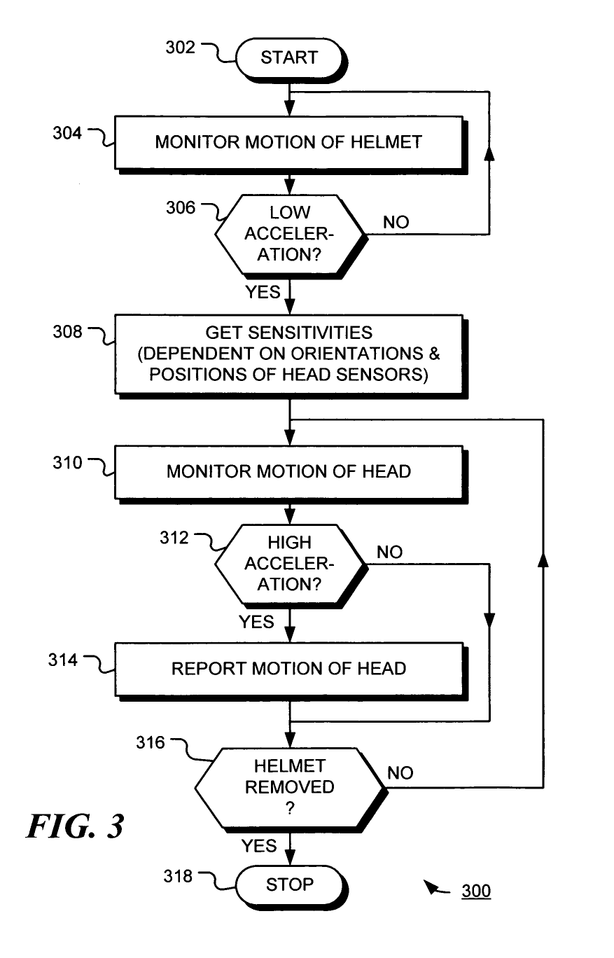

FIG. 3 is a flow chart 300 of a further method of calibration. In this embodiment, the need for identifying periods of mainly linear accelerations is avoided. Following start block 302, motion of the helmet is monitored at block 304. If the acceleration of the helmet is low enough that the helmet and head move together, as indicated by the positive branch from decision block 306, the sensitivities, which depend upon the orientations and positions of the head sensors, or a combination thereof, are determined at block 308. Exemplary methods are described in more detail below. These sensitivities constitute calibration parameters for the head-mounted sensors and may be stored in a memory for future use. Once the calibration parameters are known, the head sensors may be used at block 310 to monitor motions of the head, such as linear and rotational accelerations. If the acceleration is high, as depicted by the positive branch from decision block 312, it may indicate an impact that could cause brain injury and the head motions are reported at block 314. For example, the head motions, and/or the associated sensor signals, may be stored in a memory and/or transmitted to a device at another location.

At decision block 316, a check is made to determine if the helmet has been removed. If so, as depicted by the positive branch from decision block 316, the process ends at termination block 318, otherwise, as depicted by the negative branch from decision block 316, flow returns to block 310.

Once calibrated, the head mounted sensors may be used to monitor helmet position, since the calibration method allows relative positions to be determined.

The calibration process described above uses head mounted and helmet mounted sensors. Information, such as the sensor signals or results derived from the sensor signals, may be exchanged via wireless communication. In the embodiment shown in FIG. 1, the head sensors use a wireless link to a telemetry unit in electronic module 120 that is wired to the helmet mounted sensors. The telemetry unit may be used to transmit signals or information derived from the signals to a remote location, such as the sidelines of a sports field, or a military information center, or an ad-hoc network. The electronics module 120 may incorporate a processor that computes the calibration parameters and head motion parameters.

Acceleration at a Position on a Rigid Body

Some embodiments of the present invention use accelerometers to measure linear motion. When an accelerometer is located at a distance from the center of a body, it is responsive to both linear and rotational motions. This section describes the acceleration at a point displaced from the center of the body.

In a fixed inertial reference frame, denoted by the subscript ‘o’, the position of a point i in a rigid body at time t is given by the vector

p_{i,o}(t)=p_{b,o}(t)+R_{ob}(t)r_{i,b}, (1)

where p_{b,o} is position of the center of an origin, r_{i,b} is the fixed offset vector from the origin to the point i, and R_{ob}(t) is the rotation from the body frame of reference to the fixed frame of reference at time t. The subscript ‘b’ denotes that the quantity is referenced to the frame of the body.

The acceleration is

\ddot{p}_{i,o}(t)=\ddot{p}_{b,o}(t)+\ddot{R}_{ob}(t)r_{i,b}. (2)

In the frame of reference of the body, denoted by the subscript ‘b’, the acceleration may be written in cross product form as

\ddot{p}_{i,b}=\ddot{p}_{b,b}+\dot{ω}×r_{i,b}+ω×(ω×r_{i,b}). (3)

Accelerometers Signals

This section discloses how accelerometers, located on the calibration body or the body to be monitored, may be used to determine the motion vector of the body and/or a calibration structure.

For single, dual and triple axis accelerometers, respectively, the sensitivity matrices are defined as

$${S}_{i} = [ {η}_{i , 1}^{T} ] , {S}_{i} = [ \begin{matrix}{η}_{i , 1}^{T} \\ {η}_{i , 2}^{T}\end{matrix} ] , {S}_{i} = [ \begin{matrix}{η}_{i , 1}^{T} \\ {η}_{i , 2}^{T} \\ {η}_{i , 3}^{T}\end{matrix} ] \qquad ( 4 )$$

where η_{i,j} is the sensitivity vector (which includes the orientation of the sensing element) for axis j of the sensor at position i.

An inertial, mass-based, accelerometer also senses the acceleration due to gravity. Thus, the acceleration sensed by an accelerometer with sensitivity vector η positioned at position i, is

sᵢ=Sᵢ\ddot{p}ᵢ=Sᵢ[a+\dot{ω}×rᵢ+ω×(ω×rᵢ)], (5)

where it is assumed that the frame of reference is the body unless otherwise stated, and where

a(t)=\ddot{p}_{b,b}(t)+R_{ob}^{T}(t)g (6)

is the linear acceleration (relative to the free fall condition) and g is the gravity vector.

Equation (5) shows that accelerometer responses are dependent upon both linear and rotational motion of the body. In addition, the responses depend upon the positions of the accelerometers relative to the selected origin.

In order to determine the linear acceleration, the rotational components must be compensated for. One approach is to measure the rotation directly, using gyroscopes and/or rotational accelerometers, and compute the rotational contribution. Another approach is to use linear sensors at multiple locations and to eliminate the rotational components by appropriate combination of the sensor signals. Both of these approaches require that the sensor positions, rᵢ, be known, as well as the sensitivities of the sensors. One aspect of the present invention is related to a method and apparatus to determine rotational components of a rigid body motion from linear accelerometers when the sensor positions and orientations are unknown.

Solution for Linear and Rotational Acceleration

In matrix form, the vector of signals from sensor i can be written as

sᵢ=Sᵢ[a−K(rᵢ)\dot{ω}+K²(ω)rᵢ], (7)

where the matrix function K is defined as the skew symmetric matrix given by

$$K ( x ) {=}^{Δ} [ \begin{matrix}0 & - {x}_{3} & {x}_{2} \\ {x}_{3} & 0 & - {x}_{1} \\ - {x}_{2} & {x}_{1} & 0\end{matrix} ] \qquad ( 8 )$$

The linear acceleration vector a can be found from equation (7) when the rotational acceleration vector \dot{ω} and the rotational velocity vector ω are known. For example, the rotational velocity vector ω could be measured with a tri-axial gyroscope, and the rotational acceleration vector \dot{ω} found by differentiation with respect to time. Alternatively, the rotational acceleration vector \dot{ω} may be measured using a tri-axial rotational accelerometer and rotational velocity vector ω found by integration with respect to time.

When no rotational measurements are available, for example when only six linear accelerometers are used, equation (7) can still be solved. For example, equation (7) can be written as

$${s}_{i} = [ \begin{matrix}{S}_{i} & - K ( {r}_{i} )\end{matrix} ] [ \begin{matrix}a \\ \dot{ω}\end{matrix} ] + {S}_{i} {K}^{2} ( ω ) {r}_{i} . \qquad ( 9 )$$

This form of the equation can be thought of as a nonlinear differential equation for the unknown quantities a and \dot{ω}. There are six unknowns, so a minimum of six sensing elements are required. The equations may be solved by numerical integration at each step, provided that the initial angular velocity vector ω is known.

In particular, the signals from multiple sensors may be collected to give

$$s = [ \begin{matrix}{s}_{1} \\ {s}_{2} \\ ⋮ \\ {s}_{N}\end{matrix} ] = [ \begin{matrix}{S}_{1} & - {S}_{1} K ( {r}_{1} ) \\ {S}_{1} & - {S}_{2} K ( {r}_{2} ) \\ ⋮ & ⋮ \\ {S}_{N} & - {S}_{N} K ( {r}_{N} )\end{matrix} ] [ \begin{matrix}a \\ \dot{ω}\end{matrix} ] + [ \begin{matrix}{S}_{1} {K}^{2} ( ω ) {r}_{1} \\ {S}_{2} {K}^{2} ( ω ) {r}_{2} \\ ⋮ \\ {S}_{N} {K}^{2} ( ω ) {r}_{N}\end{matrix} ] , \qquad ( 10 )$$

This equation may be solved iteratively for a and \dot{ω}, integrating \dot{ω} at each step to find ω.

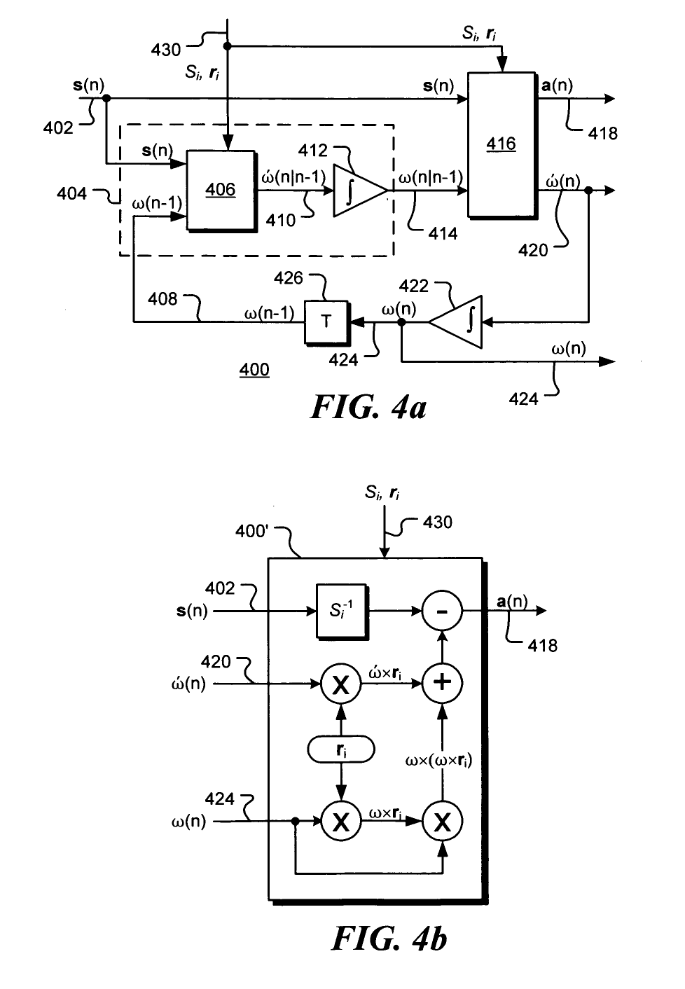

FIG. 4 is a diagrammatic representation of a system for determining linear and rotational acceleration of a rigid body, such as a helmet or a head, in accordance with some embodiments of the present invention. Equation (10) is a forward model of the rigid body dynamics, which predicts sensor signals from the linear and rotational accelerations and rotational velocity of the rigid body. The system 400 is a corresponding inverse model of the rigid body motion, which predicts the linear and rotational accelerations and rotational velocity of the rigid body from measured sensor signals.

FIG. 4 shows two example embodiments of inverse models. These models may be implemented on a programmed processor or other electronic circuit. FIG. 4a shows an inverse model that may be used when only linear accelerometer signals are available. Referring to FIG. 4a, the inverse model 400 receives the sensor signals 402 as inputs. These signals are passed to a rotational velocity predictor 404 that also receives a prior estimate 408 of the rotational velocity vector. Processor block 406 is a first partial inverse model processor that estimates the rotational acceleration vector 410 dependent upon the prior rotational velocity vector 408. This vector is integrated in first integrator 412 to give a prediction 414 of the rotational velocity vector. This prediction is based on the current sensors signals 402 and the prior rotational velocity vector 408. Processor block 416 is a second partial inverse model processor that estimates the linear acceleration vector 418 and the rotational acceleration vector 420 dependent upon the predicted rotational velocity vector 414. The rotational acceleration vector 420 is integrated in a second integrator 422 to provide an estimate 424 of the current rotational velocity vector. The estimate 424 is held in delay unit 426 to provide the rotational velocity vector 408 ready for processing of the next samples of the sensors signals 402. Thus, both linear (418) and rotational (420) acceleration vectors are estimated. The partial inverse models 406 and 416 use calibration parameters 430 that relate to the sensitivities, orientations and positions of the sensors.

FIG. 4b shows a further embodiment of an inverse model 400′ that may be used when both linear accelerometer signals 402 and rotational sensor signals are available. The rotational acceleration vector 420 may be obtained from rotational accelerometers or may be derived by time differentiation of signals from rotational velocity or position sensors. The rotational velocity vector 424 may be obtained from rotational velocity sensors, such as gyroscopes, or may be obtained by integrating signals from rotational accelerometers. This inverse model is simpler than that shown in FIG. 4a, since the rotational velocity signals are measured directly rather than being computed by combining linear sensor signals. Referring again to FIG. 4b, inverse model 400′ estimates the linear acceleration vector 418 dependent upon the rotational acceleration vector 420 and the rotational velocity vector 424. The linear acceleration is given by: a=Sᵢ⁻¹sᵢ−[\dot{ω}×rᵢ+ω×(ωrᵢ)], which is obtained by solving equation (5), above.

Other inverse models will be apparent to those of ordinary skill in the art. The inverse models may be implemented on a programmed processor, such as a Digital Signal Processor (DSP), microcontroller, Field Programmable Gate Array, or the like.

In one embodiment, where only linear accelerometers are used, the partial inverse model implements the equations

$$[ \begin{matrix}a ( n ) \\ \dot{ω} ( n )\end{matrix} ] = {[ \begin{matrix}{S}_{1} & - {S}_{1} K ( {r}_{1} ) \\ {S}_{1} & - {S}_{2} K ( {r}_{2} ) \\ ⋮ & ⋮ \\ {S}_{N} & - {S}_{N} K ( {r}_{N} )\end{matrix} ]}^{†} ( s ( n ) - [ \begin{matrix}{S}_{1} {K}^{2} ( \hat{ω} ( n ) ) {r}_{1} \\ {S}_{2} {K}^{2} ( \hat{ω} ( n ) ) {r}_{2} \\ ⋮ \\ {S}_{N} {K}^{2} ( \hat{ω} ( n ) ) {r}_{N}\end{matrix} ] ) , \qquad ( 10 )$$

Where, in processor 306, \hat{ω}(n)=ω(n−1) is the prior rotational velocity estimate and, in processor 416, \hat{ω}(n)=ω(n|ω(n−1),s(n))≡ω(n|n−1). ω(n|n−1) is the estimate of the rotational velocity vector given the current signals and the past rotational velocity vector. The superposed dagger in equation (10) denotes a pseudo inverse. Equation (7) is a forward model which shows how sensor signals are produced from a motion vector, whereas equation (10) is the corresponding inverse model which shows how a motion vector may be produced from sensor signals.

The above method uses at least one integrator if rotational sensors are unavailable. This integrator may be avoided if at least nine linear sensing channels are used. In the application for helmet and head motion sensing, a sensor may not be placed at the center of the helmet or head, so at least 10 linear sensors are needed.

By way of explanation, equation (7) may be written as

$$\begin{matrix}\begin{matrix}{s}_{i} = {S}_{i} a - {S}_{i} {K ( {r}_{i} )}_{i} \dot{ω} + {S}_{i} P ( {r}_{i} ) γ ( ω ) \\ = [ \begin{matrix}{S}_{i} & - {S}_{i} K ( {r}_{i} ) & {S}_{i} P ( {r}_{i} )\end{matrix} ] [ \begin{matrix}a \\ \dot{ω} \\ γ ( ω )\end{matrix} ] ,\end{matrix} \\ where & ( 11 ) \\ P ( r ) = [ \begin{matrix}0 & {r}_{1} & 0 & {r}_{2} & 0 & {r}_{3} \\ 0 & 0 & {r}_{2} & {r}_{1} & {r}_{3} & 0 \\ {r}_{3} & 0 & 0 & 0 & {r}_{2} & {r}_{1}\end{matrix} ] , \\ γ ( ω ) = [ \begin{matrix}- {ω}_{1}^{2} - {ω}_{2}^{2} \\ - {ω}_{2}^{2} - {ω}_{3}^{2} \\ - {ω}_{3}^{2} - {ω}_{1}^{2} \\ {ω}_{1} {ω}_{2} \\ {ω}_{2} {ω}_{3} \\ {ω}_{3} {ω}_{1}\end{matrix} ] . & ( 12 )\end{matrix}$$

γ(ω) is a vector of centripetal components that depends upon the rotational velocity vector ω. The parameters in the matrices Sᵢ, −SᵢK(rᵢ) and SᵢP(rᵢ) in equation (11) denote the sensitivities to linear, rotational and centripetal accelerations, respectively. The sensor response is therefore completely determined by the rigid body sensitivity parameters, denoted by the matrix Gᵢ=[Sᵢ −SᵢK (rᵢ) SᵢP(rᵢ)], and the motion vector

$$m = [ \begin{matrix}a \\ \dot{ω} \\ γ ( ω )\end{matrix} ] .$$

Collecting terms from N sensors gives

$$s = [ \begin{matrix}{s}_{1} \\ {s}_{2} \\ ⋮ \\ {s}_{N}\end{matrix} ] = [ \begin{matrix}{S}_{1} & - {S}_{1} K ( {r}_{1} ) & {S}_{1} P ( {r}_{1} ) \\ {S}_{2} & - {S}_{2} K ( {r}_{2} ) & {S}_{2} P ( {r}_{2} ) \\ ⋮ & ⋮ & ⋮ \\ {S}_{i} & - {S}_{N} K ( {r}_{N} ) & {S}_{N} P ( {r}_{N} )\end{matrix} ] [ \begin{matrix}a \\ \dot{ω} \\ γ ( ω )\end{matrix} ] {=}^{Δ} Gm , \qquad ( 13 )$$

The matrix equation (13) may be solved for the unknown vectors α, \dot{ω} and γ that form the motion vector. There are 12 unknown values, so in general the solution requires at least 12 acceleration measurements, provided the matrix on the right hand side (which depends only on the positions and sensitivities of the sensors) is invertible. For 12 or more sensors the solution for the motion vector is m=G^{†}s, where the superposed dagger denotes the inverse or pseudo-inverse of the matrix.

However, if the solution for γ is not required, the equations may be solved for the vectors a and \dot{ω} with fewer sensors, provided the accelerometer positions are chosen to exploit the symmetry in the equations such that the equations may be decoupled. The solution for γ, if required, may then be found by numerical integration of the rotational acceleration.

The inverse models described above assume that the sensitivities, positions and orientations of the sensors are known. This is a reasonable assumption for the reference sensors that are attached to a substantially rigid calibration structure, such as a helmet, but the positions and orientations of sensors applied in-situ to a head, or other body, are not known in advance. Measuring the positions and orientations in-situ would be time consuming and difficult. Further, calibrating the sensors for sensitivity in advance adds significant cost to the sensors. In accordance with one aspect of the present invention, the sensors are calibrated in-situ relative to the reference sensors. Several, exemplary methods for in-situ calibration are described below.

Calibration of Sensor Orientation

Equation (5) may be written as

sᵢ=Sᵢa+Sᵢ[K(\dot{ω})+K²(ω)]rᵢ (14)

For linear accelerations, the sensor signals are independent of sensor positions. This is true for linear motions, but also when the body is stationery and subject to gravity. Collecting multiple samples (for example, with the body in different orientations with respect to gravity) gives

Vᵢ=SᵢA, (15)

where

Vᵢ=[sᵢ(0) sᵢ(1) . . . sᵢ(n)] and A=[a(0) a(1) . . . a(n)]. (16)

Equation (16) may be solved for the sensitivity matrix Sᵢ, which includes orientation information, to give

Sᵢ=VᵢA^{†}, (17)

where A^{†} is the pseudo inverse of A. This approach avoids having to calibrate each head sensor before use, and also measures the orientation of each sensor after it has been located on the head.

Calibration of Sensor Positions

For multiple time samples, equation (5) may be written as

$$\begin{matrix}s = α + {Er}_{i} , \\ where & ( 18 ) \\ s = [ \begin{matrix}{s}_{i} ( 0 ) \\ {s}_{i} ( 1 ) \\ ⋮ \\ {s}_{i} ( n )\end{matrix} ] , \\ α = [ \begin{matrix}{S}_{i} a ( 0 ) \\ {S}_{i} a ( 1 ) \\ ⋮ \\ {S}_{i} a ( n )\end{matrix} ] , \\ and \\ E = [ \begin{matrix}{S}_{i} [ K ( \dot{ω} ( 0 ) ) + {K}^{2} ( ω ( 0 ) ) ] \\ {S}_{i} [ K ( \dot{ω} ( 1 ) ) + {K}^{2} ( ω ( n ) ) ] \\ ⋮ \\ {S}_{i} [ K ( \dot{ω} ( n ) ) + {K}^{2} ( ω ( n ) ) ]\end{matrix} ] . & ( 19 )\end{matrix}$$

The linear acceleration signals in the vector α and the rotations in the matrix E can be measured using the helmet sensors, so equation (19) can be solved to give the positions of the head sensors relative to the helmet, for example

rᵢ=(E^{T}E)⁻¹ E^{T}(s−α). (20)

This approach assumes that linear sensitivity matrix Sᵢ, which includes orientation information, is known.

Joint Calibration

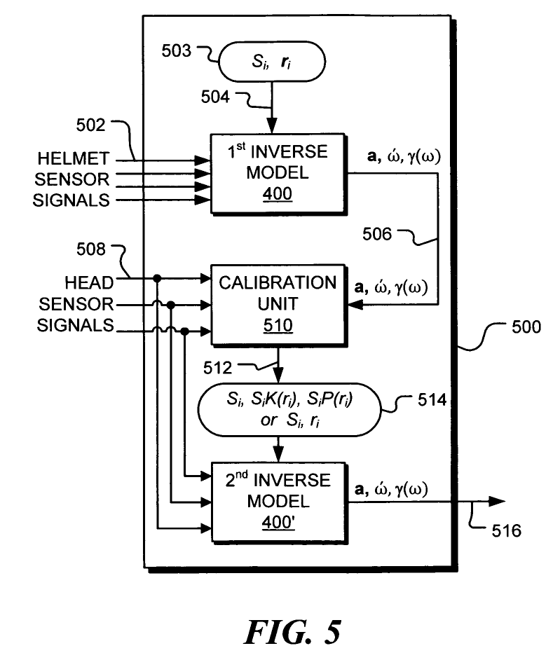

FIG. 5 is a diagrammatic representation of a system 500 for monitoring head motion that provides for in-situ calibration of head sensors. The in-situ calibration uses measurements made by helmet sensors. More generally, motion of a body is monitored by body-mounted sensors that are calibrated in-situ using reference sensors responsive to the motion of the body. The system 500 may be incorporated with the electronics module 120 shown in FIG. 1, or may be implemented in a remote processor that receives signals from a telemetry unit in electronics module 120.

Referring to FIG. 5, a first inverse model processing module 400 receives signals 502 from helmet (reference) sensors and accesses calibration data 504 for the helmet (reference) sensors. The calibration data 504 may be stored in a memory 503 and may comprise the sensitivities, orientations and positions of the sensors. The output from the module 400 comprises the vectors a, \dot{ω} and γ, (506), which together form a motion vector. A calibration processing unit 510 receives the motion vectors 506 and the signals 508 from the head sensors. From equation (11), these signals are related by

$${s}_{i} ( t ) = {S}_{i} [ \begin{matrix}I & - K ( {r}_{i} ) & P ( {r}_{i} )\end{matrix} ] [ \begin{matrix}a ( t ) \\ \dot{ω} ( t ) \\ γ ( ω ( t ) )\end{matrix} ] {=}^{Δ} {G}_{i} m ( t ) , \qquad ( 21 )$$

where Gᵢ=[Sᵢ −SᵢK(rᵢ) SᵢP (rᵢ)] is the matrix of rigid body sensitivities and

$$m ( t ) = [ \begin{matrix}a ( t ) \\ \dot{ω} ( t ) \\ γ ( ω ( t ) )\end{matrix} ]$$

is the motion vector.

Collecting samples (during time intervals when the motion of the head is small enough that the helmet moves with the head, or during times when the calibration structure is coupled to the body to be monitored), allows us to write

Vᵢ=GᵢM (22)

where

M=[m(0) m(1) . . . m(n)] (23)

is a matrix of motion vectors at different sample times. Equation (22) may be solved formally for the matrix of rigid body sensitivities

Gᵢ=VᵢM^{†}, (24)

where the superposed dagger denotes the pseudo-inverse of the matrix. This computation, or its equivalent, is performed by the calibration unit 510.

Equation (22) may also be solved iteratively, using an adaptive algorithm of the form

Gᵢ(n)=Gᵢ(n−1)+μ[sᵢ(n)−Gᵢ(n−1)m(n)]W(n)m^{T}(n), (25)

where μ is a step size parameter and W(n) is a weighting matrix.

Other adaptive algorithms will be apparent to those of ordinary skill in the art, and may be implemented in the calibration unit 510.

Thus, the matrix of rigid body sensitivities Gᵢ=[Sᵢ −SᵢK(r)SᵢP(rᵢ)] can be found, provided that sufficient samples are collected to enable the matrix inversion.

The terms Sᵢ, −SᵢK(rᵣ) and SᵢP(rᵢ) correspond to the linear, angular and centripetal acceleration sensitivities, respectively, of the head sensors. These sensitivities are dependent upon the properties of the sensing elements, the orientation of the sensing elements and the positions of the sensing elements.

The computation described by equation (24), or its equivalent, is performed by calibration unit 510. The resulting sensitivity matrix Gᵢ=[Sᵢ −SᵢK(rᵢ) SᵢP(rᵢ)] (512) for the head sensors is output from the calibration unit 510 and is stored in a memory 514.

For tri-axial accelerometers, Sᵢ may be inverted to allow the matrices K(rᵢ) and P(rᵢ) to be estimated. Further, the solution may be corrected by, for example forcing K(rᵢ) to be skew symmetric (e.g. replacing K(rᵢ) with (K(rᵢ)−K^{T}(rᵢ))/2).

In this approach, calibration may be performed without the need to identify periods of purely linear accelerations.

Additionally, since the linear sensitivity matrix Sᵢ is now known, the sensor positions may be computed using equation (20) above. Optionally, the matrix of sensitivities, Gᵢ, may be recalculated from the positions and the linear sensitivities, however, it is not necessary to find explicit forms for K(rᵢ) and P(rᵢ), since equation (10) may be used to monitor the motion.

A second inverse model 400′, in FIG. 5, is implemented to compute the head motions from the head sensor signals. This second inverse model may include the partial model in equation

$$[ \begin{matrix}a ( n ) \\ \dot{ω} ( n )\end{matrix} ] = {[ \begin{matrix}{S}_{1} & - {S}_{1} K ( {r}_{1} ) \\ {S}_{2} & - {S}_{2} K ( {r}_{2} ) \\ ⋮ & ⋮ \\ {S}_{N} & - {S}_{N} K ( {r}_{N} )\end{matrix} ]}^{†} ( s ( n ) - [ \begin{matrix}{S}_{1} P ( {r}_{1} ) \\ {S}_{2} P ( {r}_{2} ) \\ ⋮ \\ {S}_{N} P ( {r}_{N} )\end{matrix} ] γ ( \hat{ω} ( n ) ) ) . \qquad ( 26 )$$

The second inverse model 400′ is responsive to the head sensor signals 508 and calibration parameters stored in memory 514. Other inverse models are discussed above with reference to FIG. 4.

An advantage of the form of the inverse model given in equation (26) is that the matrix terms on the right hand side depend only on the rigid body sensitivity matrices. These matrices and the pseudo inverse matrix in equation (26), may be computed once following calibration and do not need to be computed at each time step.

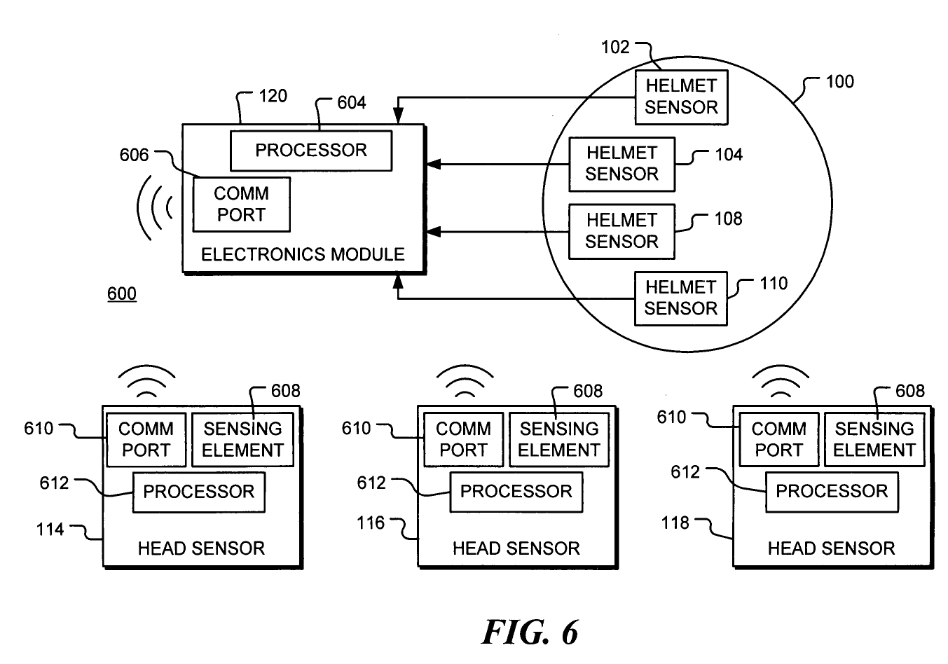

FIG. 6 is a diagrammatic representation of a head motion monitoring system in accordance with some embodiments of the invention. Referring to FIG. 6, the system 600 includes a helmet 100 instrumented with a plurality of sensors 102, 104, 108 and 110. More generally, 100 is a substantially rigid calibration structure and the helmet sensors are reference sensors. The signals from the helmet sensors are passed to an electronics module 120. The electronics module may be integrated with the helmet 100 or remote from it. The electronics module 120 includes a processor 604 and a communication or telemetry port 606 as well as other standard elements such as clocks, power supply, etc. The processor 604 is operable to determine the motion of the helmet from the helmet sensor signals, and from pre-determined calibration data relating to the positions, orientations and locations of the helmet sensors. In one embodiment, the processor 604 implements the system 500, shown in FIG. 5.

The system 600 also includes a plurality of body-mountable sensors 114, 116 and 118 adapted to be attached to the helmet wearer's head (or other body to be monitored). The sensors each include sensing elements 608, such as tri-axial or bi-axial accelerometers and/or rotation sensors for example, a communication port 610, adapted for wireless communication with the communication port 606 of the electronics module 120 or with a remote location, and a processor 612. Each processor 612 receives signals from the sensing element 608 and is operable to pass the signals, or information derived from the signals, to the communication port 610. In one embodiment, three biaxial accelerometers are used, so each head sensor has two sensing elements. In a further embodiment one or more head sensors are used, each having three linear sensing elements and three rotational sensing elements.

The processor 604 of the electronics module 120 is operable to compute calibration parameters for the head sensors. The processor 604, or one or more of the sensor processors 612, may be operable to compute motion of the head from the head sensors.

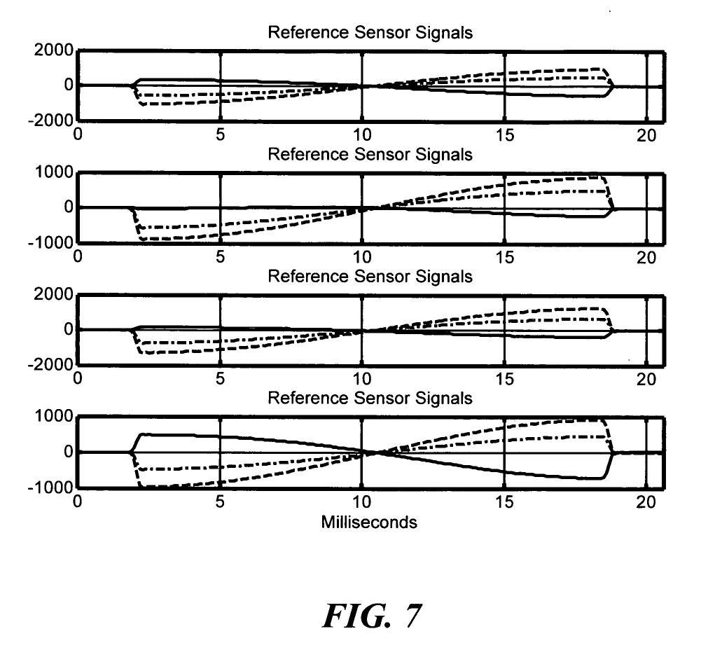

FIG. 7 shows plots of reference sensor signals for a simulated head motion. In this example, the top reference sensor is at the right side of the helmet, the next reference sensor is at left side of the helmet, the third sensor is at the top of the helmet and the fourth reference sensor is at the rear of the helmet. Each sensor is a tri-axial accelerometer, and the lines in each plot correspond to the three sensing axes of each sensor.

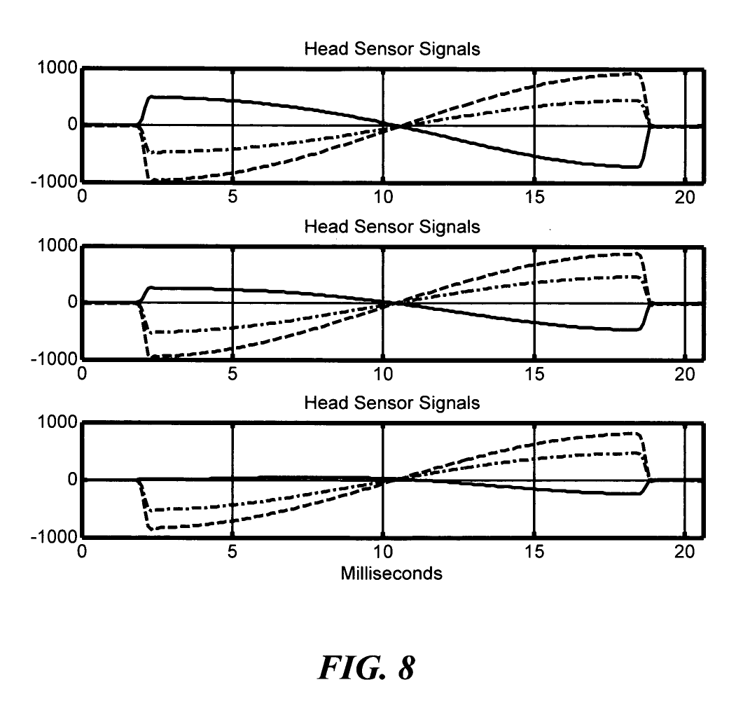

FIG. 8 shows corresponding plots of head sensor signals for the simulated head motion. In this example, the top reference sensor is at the right side of the head, the next reference sensor is at left side of the head, and the third sensor is at the front of the head. Again, in this example, each sensor is a tri-axial accelerometer, and the lines in each plot correspond to the three sensing axes of each sensor.

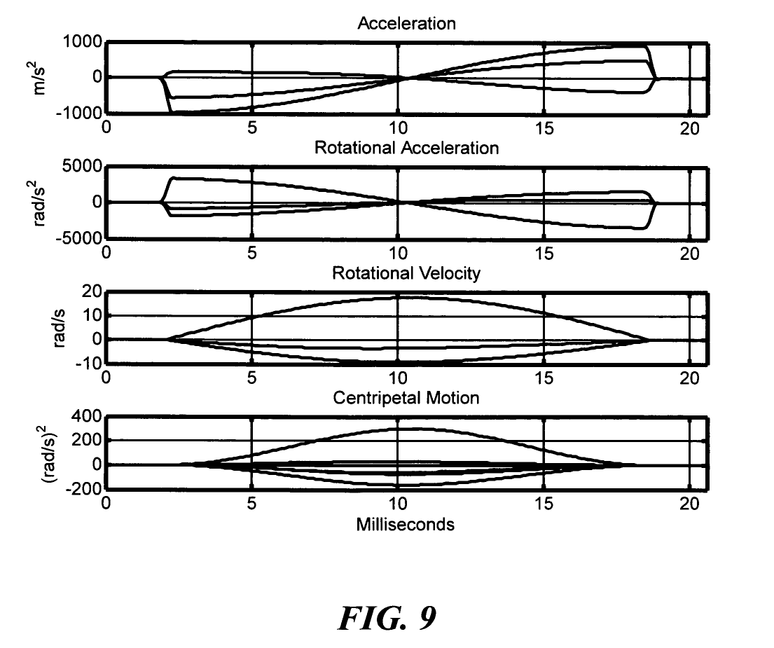

FIG. 9 shows the motion of the head. The plots, from top to bottom, show the linear acceleration components, the rotational acceleration components, the rotational velocity components and the centripetal velocity components (which are a non-linear function of the rotational velocity components). The motion has been determined in two ways. Firstly, the motion has been determined from the reference (helmet) sensors using knowledge of the positions and sensitivities of the sensors. The linear and rotational accelerations were determined directly using the symmetry of the sensing array, and the velocity components were determined by numerical integration. Secondly, the motion has been determined by (a) calibrating the head sensors using prior motion information and then (b) determining the motion from the head sensor signals.

Thus, it has been demonstrated that head motion may be monitored using head mounted sensors that have been calibrated in-situ using helmet mounted sensors. The calibration parameters comprise one or more of the linear sensitivity, the rotational sensitivity and the centripetal sensitivity of the head sensors and are dependent upon the positions and orientations of the head sensors. Alternatively, the calibration parameters comprise the linear sensitivities, the orientations and the positions of the sensors.

The monitored head motion may be transmitted to and displayed on a remote display unit, or stored in a local and/or remote memory.

In one embodiment, the reference sensors on the helmet comprise tri-axial sensors at positions with Cartesian coordinates (a,0,0) and (−b,0,0), and dual-axis sensors at positions with Cartesian coordinates (0,c,0) and (0,0,d), relative to the origin (0,0,0). This enables the rigid body motions to be determined by simple algebraic combinations of the sensor signals. The linear motion is obtained from the two tri-axial sensors. It will be apparent to those of ordinary skill in the art that various arrangements and combinations of reference sensors may be used, including rotational accelerometers, gyroscopes, magnetic sensors, and geophones for example.

In the foregoing discussion, methods and apparatus for calibrating head mounted motion sensors and monitoring head motion have been presented. A further aspect of the present invention relates to combinations and arrangements of head mounted sensors that enable the monitoring of both linear and rotational components of head motion. These configurations may be used to monitor other rigid bodies, or body parts other than a human head. For example, in one application, sensors are attached to a limb at various locations. A calibration body, comprising reference sensors on a substantially rigid calibration structure, is also attached. In a first time period the body-mounted sensors are calibrated using the calibration body. The calibration body is then removed, after which motion of the limb is monitored by the body-mounted sensors. This approach allows inexpensive and possibly disposable body-mounted sensors to be used without the need for time consuming and complex measurements of sensor positions and orientations.

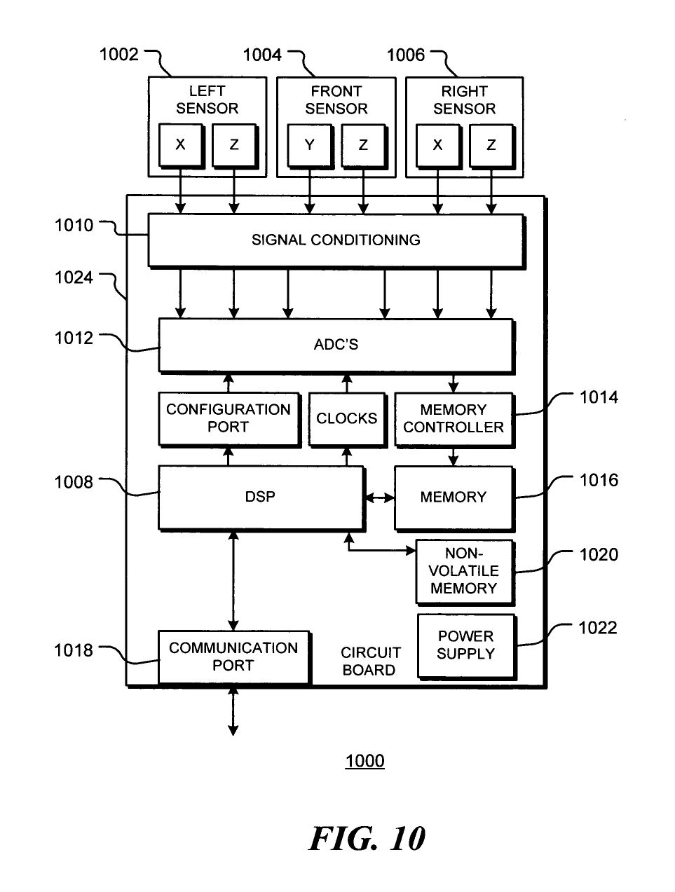

FIG. 10 is a block diagram of an example apparatus for sensing motion of a body, in accordance with some embodiments of the invention. Referring to FIG. 10, the apparatus 1000 includes motion sensors 1002, 1004 and 1006 each having two sensing axes. The motion sensors may be linear or rotational accelerometers, for example, or rotation rate sensors. Different numbers of sensors may be used, each have one or more sensing axes. However, the total number of sensing axes should be at least six, since a rigid body has six degrees of freedom of motion. The sensors may be reference sensors coupled to the substantially rigid calibration structure, or body mounted sensors, such as head sensors.

The motion sensors generate sensed signals that are received by a processor 1008. In the embodiment shown, the processor is a digital signal processor (DSP), but other types of processors may be used. In this embodiment, the sensor signals are passed through signal conditioning circuits 1010, then sampled using analog to digital converters (ADC's) 1012 and then sent by a memory controller 1014 (such as a DMA controller) to be stored in a memory 1016. The memory may be internal or external to the processor 1008. The processor 1008 may then retrieve the sensed signals from the memory 1016. Alternately, the sampled signals could be passed directly to the processor.

In other embodiments, sensors signals may be sampled at the sensors, as in FIG. 6, for example, and communicated to a common processor over a wired or wireless communications link.

The processor 1008 processes the sensed signals and generates parameters that characterize the motion of the rigid body to which the motion sensors 1002, 1004 and 1006 are coupled. The motion parameters are passed to a communication or output port 1018 and/or stored in a local memory, such as memory 1016 or non-volatile memory 1020, for later retrieval.

The non-volatile memory 1020 may also be used to store one or more identifiers of the apparatus. The identifiers may be communicated with the motion parameters.

Power supply 1022 may be a battery, for example, and may supply power to the processor 1008, the sensors 1002, 1004 and 1006, and other component of the circuit.

One or more sensors may be integrated on the electronics module 1024 that includes the processor 1008 and other components. In a further embodiment, each sensor may have its own processor. The electronics module 1024 may be a flexible circuit, as discussed below.

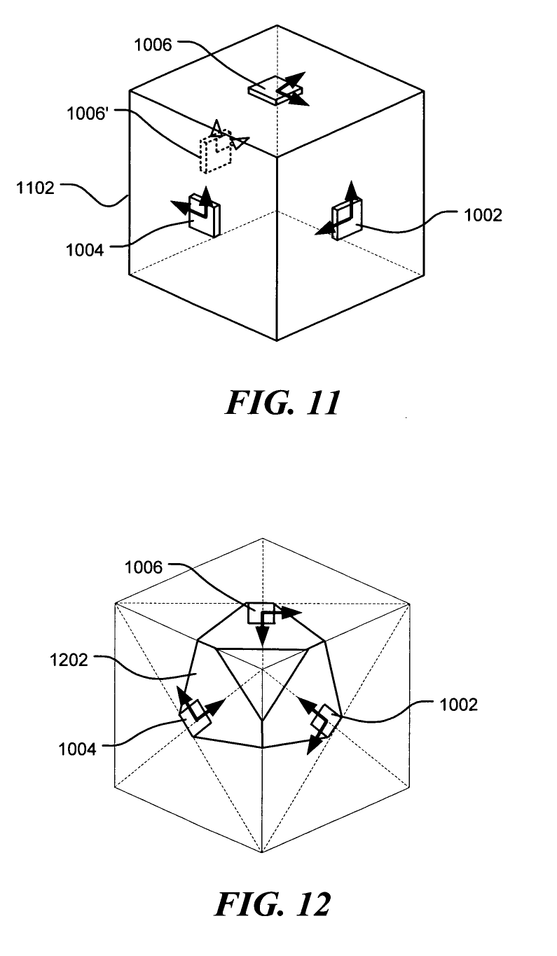

FIG. 11 shows an example sensor configuration, in accordance with some embodiments of the invention. In this configuration there are three bi-axial motion sensors, 1002, 1004 and 1006, arranged on different faces of a rigid body 1102. In an alternative arrangement, the sensors 1002, 1004 and 1006′ are used. Here, the sensing axes of sensor 1006′ are not orthogonal to those of sensor 1002, and are in a different plane.

FIG. 12 is an example of a sensing structure 1202, in accordance with some embodiments of the invention. In this embodiment, the motion sensors 1002, 1004 and 1006 are attached to a rigid sensing structure 1202. The sensing structure 1202 maintains the sensors in fixed orientations relative to one another, and at fixed positions relative to one another. In use, the sensing structure is coupled to the substantially rigid body that is to be sensed or monitored. The sensing structure may be attached to a substantially rigid calibration structure (such as a helmet) or to the body to be monitored.

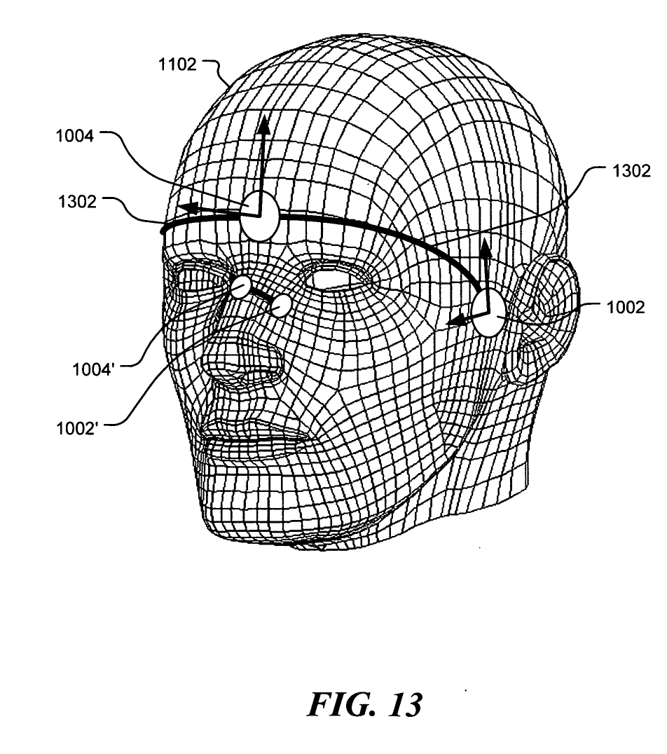

FIG. 13 shows two example sensor configurations for sensing motion of a head, in accordance with some embodiments of the invention. The embodiment uses sensors 1002, 1004 and 1006. Sensor 1002 is located on the left side of the head, while sensor 1006 (not shown) is located in a corresponding position on the right side of the head. Sensor 1004 is on the forehead, but sensor 1004′ may be used as an alternative to sensor 1004. The sensors may be physically connected by connecting band 1302. The connecting band 1302 may pass sensed signals and power signals between the sensors. In one embodiment, the sensors are mounted in an elastic head band that couples to the sensors to the head.

In further embodiments, the sensors may be embedded in patches attached by adhesive to the head, as disclosed in U.S. Pat. No. 7,174,277 for example. Optionally, the connecting band 1302 may also be adhesive-backed. The connecting band helps to ensure that the sensor are placed on the head with known orientations and known positions and also provides additional surface area to provide good coupling to the head.

The connecting band 1302 may include a sensor, such as a strain sensor, that enables the relative positions and orientations of the sensors to be determined.

A processor may be integrated with one of the sensors (such as sensor 1004) and may include a wireless transceiver for communication with a remote location. When three individual patches are used, three transceivers are required and steps must be taken to ensure that the sensed signals are time aligned or synchronized, thus there is an advantage to having coupled sensors.

The sensors may be attached to the head at various positions. The optimal positions may depend upon the application. For example, in an alternative embodiment, the sensors are attached to the bridge of the nose as indicated by 1002′ and 1004′. Sensor 1006′ is attached on the other side of the nose. The sensors may be flexibly coupled or coupled via a rigid sensing structure. The coupled sensors form a nose band. Cantilevered spring strips may be attached the sensing structure. The strips adhere to and thereby expand the lower part of the nose to aid breathing (similar to Breathe-Right™ nasal strips marketed by GlaxoSmithKline). This provides a combined impact monitor and breathing aid.

The sensors may include MEMS linear accelerometers, MEMS rotational accelerometers, and/or MEMS gyroscopes, for example. When rotational sensors are used, they may be mounted in a single patch. For example, a single patch at position 1004′ may be used.

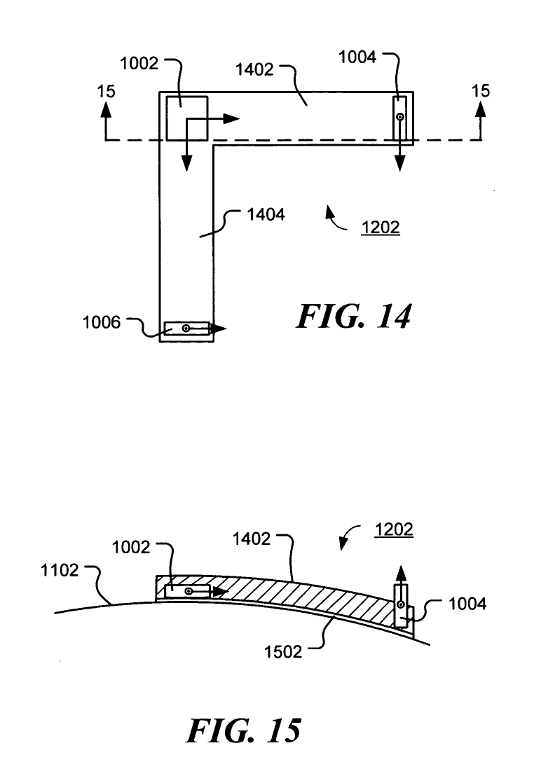

FIG. 14 is a further example of a sensing structure, in accordance with some embodiments of the invention. The sensing structure 1202 comprises two arms 1402 and 1404. In this embodiment the arms are shown orthogonal to one another, but in general the arms may be any angle to one another and may have different shapes. For example, for use on the bridge of a nose, the arms may be aligned in the same direction. Attached to the structure 1202 (or embedded in it) are three sensors 1002, 1004 and 1006. In this embodiment, three bi-axial sensors are used, but a different number of sensors and axes may be used, provided that at least six independent motions may be sensed. In the embodiment shown in FIG. 14, the sensors are arranged orthogonally as shown in FIG. 11, but other arrangements may be used.

FIG. 15 is a cross-sectional view through the section 15-15 shown in FIG. 14. In FIG. 15, the sensing structure is shown attached to the surface of a substantially rigid body 1102 via an adhesive layer 1502. The arm 1402 is deformed to follow the curved surface of the rigid body 1102. Preferably, the arms 1402 and 1404 are constructed so as to be more compliant with respect to shear than to flexion. This may be achieved using an anisotropic material, such as a material having layers aligned perpendicular to the surface. An advantage of an arm that deforms in shear rather than flexion is that the orientation of the sensor 1004 with respect to the sensor 1002 is maintained. For application to head impact monitoring, the structure may be located on the head behind an ear, for example.

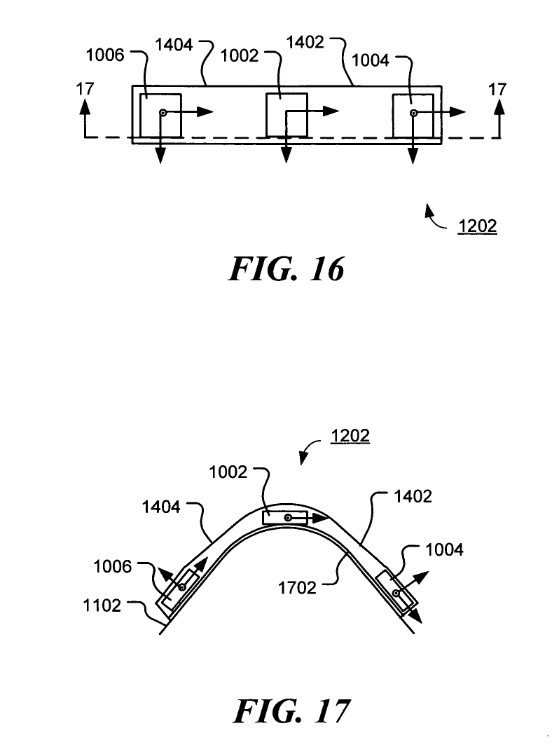

FIG. 16 is a further example of a sensing structure, in accordance with some embodiments of the invention. The sensing structure 1202 comprises two arms, 1502 and 1504. In this embodiment the arms are shown aligned in the same direction. Attached to the structure 302 (or embedded in it) are three sensors 1002, 1004 and 1006. In this embodiment, three bi-axial sensors are used, but a different number of sensors and axes may be used, provided that at least six independent motions may be sensed. The structure 1202, including the arms 1402 and 1404, may comprise a flexible circuit board or ‘flex-circuit’ that links the sensors 1002, 1004 and 1006, the processor (not shown), a power supply (such as a battery) and other components of the circuit. The circuit board includes circuits for carrying signals between a processor and the sensors and for supplying power. When both linear and rotational sensors are used they may be substantially co-located.

FIG. 17 is a cross-sectional view through the section 17-17 shown in FIG. 16. In FIG. 17, the sensing structure is shown attached to the surface of a substantially rigid body 1102 via an adhesive layer 1502. In this example, the surface is highly curved as is the case the bridge of a nose (as shown in FIG. 13). The arms 1402 and 1404 are deformed to follow the curved surface of the body 1102. This deformation moves the sensors out of a common plane, so that six independent motions may be sensed. There is no requirement that the sensing axes be orthogonal, however, the sensors 1004 and 1006 may be aligned at an angle to the structure 1202 such that the sensors are closer to orthogonal when the structure is attached to the bridge of a nose.

Optionally, one or more of the sensors may be a tri-axial sensor, as shown for sensors 1004 and 1006 in FIG. 16 and FIG. 17.

The remarks above have shown how the motion parameters of a selected location on a substantially rigid body may be determined using a plurality of motion sensors displaced from the selected location. This is achieved by coupling the plurality of motion sensors to locations on the surface of the rigid body, determining the relative orientations of the sensing axes of the plurality of motion sensors, determining the positions of the plurality of motion sensors relative to the selected location and then calculating each motion parameter as a weighted sum of output signals from the plurality of motion sensors. The weightings in the weighted sum are dependent upon the relative orientations of the sensing axes of the plurality of motion sensors and the positions of the plurality of motion sensors relative to the selected location.

In contrast to prior approaches, none of the sensing axes of the plurality of motion sensors need be directed towards the selected location. For example, the sensing axes of the plurality of motion sensors may be oriented tangentially with respect to the surface of the substantially rigid body. This allows the use of bi-axial MEMS accelerometers, for example.

The motion parameters may be determined from a total of six or more sensed signals.

The relative orientations of the sensing axes of the motion sensors may be determined by sensing the earth's gravitation field using at least one gravity sensor in a fixed orientation to the sensing axes. In one embodiment, in which the one or more motion sensors are accelerometers, the relative orientations of the sensing axes are determined by sensing gravity using the accelerometers. The average value of the accelerometer reading is proportional to the acceleration due to gravity multiplied by the cosine of the angle between the sensing axis and the vertical direction.

In a further embodiment, the relative orientations of the sensing axes are determined by moving the rigid body in a controlled motion and comparing the output signals of the motion sensors. For example, the rigid body may be subject to a pure translation or a pure rotation (about the selected location or some other location).

The motion parameters may comprise three components of the linear motion of the selected location and three components of rotation of the substantially rigid body.

Combination of the sensor signals requires that the relative and/or absolute sensitivities of the sensors be determined. The relative sensitivities of the motion sensors may be determined by subjecting the sensors to a common disturbance. The absolute sensitivities of the motion sensors may be determined by subjecting the sensors and one or more reference sensors to a common disturbance.

An apparatus for sensing motion parameters of a selected location on a substantially rigid body, includes a plurality of motion sensors adapted to couple to the rigid body at positions displaced from the selected location and to produce a plurality of sensed signals in response to motion of the substantially rigid body. The apparatus further includes a processor that receives the sensed signals and calculates each motion parameter as a weighted sum of the sensed signals from the plurality of motion sensors and produces the motion parameters as output. The weightings in the weighted sum are dependent upon the relative orientations of the sensing axes of the plurality of motion sensors and the positions of the plurality of motion sensors relative to the selected location, as described above.

The processor may be a programmed processor, such as a microprocessor or digital signal processor, or an application specific integrated circuit, or a field programmable gate array, for example. The apparatus may also include an output port that communicates the motion parameters over an output channel that may be wired or wireless. The motion parameters may be stored in a local or remote memory.

The processor may be mounted on a common structure with at least one of the motion sensors and the associated sensed signals may be physically connected to the processor.

The processor may coupled to one or more motion sensors and receive the sensed signals from the other motion sensors via a wireless connection.

The processor may be remote from the plurality of motion sensors and receive the sensed signals of the plurality of motion sensors via a wireless connection.

In one embodiment, the motion sensors include three bi-axial accelerometers.

In a further embodiment, the motion sensors include rotational sensors.

The motion sensors may be mounted on a common structure in a fixed orientation relative to each other. For example, the substantially rigid body may be a human a head and the common structure may be a helmet.

In a further embodiment, the three bi-axial accelerometers are coupled to adhesive backed patches that couple to the surface of the rigid body. The patches may or may not be physically coupled to one another.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for determining the sensitivity of a sensor located on a first rigid body to motion of the first rigid body, the method comprising:
determining a motion vector of the first rigid body at a plurality of sample times using a plurality of reference sensors coupled to the rigid body;
measuring the response of the sensor at the plurality of sample times;
estimating calibration parameters that describe the sensitivity of the sensor to rigid body motion dependent upon the motion vector at the plurality of sample times and the response of the sensor at the plurality of sample times, and
outputting the estimated calibration parameters.

2. A method in accordance with claim 1, wherein, at each sample time of the plurality of sample times, the motion vector comprises three components of linear motion and three components of rotational motion.

3. A method in accordance with claim 1, wherein, at each sample time of the plurality of sample times, the motion vector comprises three components of a linear acceleration vector, a, three components of a rotational acceleration vector \dot{ω} and six components of a centripetal acceleration vector γ(ω) of the first rigid body, where γ(ω) is a non-linear function of the rotational speed vector ωof the first rigid body.

4. A method in accordance with claim 1, wherein determining the motion vector of the first rigid body comprises measuring a motion vector of a substantially rigid calibration structure that moves with the first rigid body at the plurality of sample times.

5. A method in accordance with claim 4, wherein the first rigid body comprises a head and substantially rigid calibration structure comprises a helmet.

6. A method in accordance with claim 4, wherein determining the motion vector of the first rigid body comprises measuring linear accelerations of the substantially rigid calibration structure at one or more locations.

7. A method in accordance with claim 6, wherein determining the motion vector of the first rigid body further comprises:
determining the rotational acceleration \dot{ω} of the first rigid body,
integrating the rotational acceleration \dot{ω} of the first rigid body with respect to time to estimate the rotational speed ω, and
estimating centripetal accelerations of the first rigid body from the estimated rotational speed ω.

8. A method in accordance with claim 6, wherein determining the motion vector of the first rigid body further comprises:
measuring the rotational speed ω of the first rigid body, using at least one rotational speed sensor, and
estimating centripetal accelerations of the first rigid body from the measured rotational speed.

9. A method in accordance with claim 1, wherein the calibration parameters comprise the linear sensitivity, position and orientation of the sensor.

10. A method in accordance with claim 1, wherein the sensor comprises an accelerometer and wherein the calibration parameters comprise the sensitivities of the sensor to linear, rotational and centripetal accelerations.

11. A method for monitoring motion of a head comprising:
attaching a plurality of sensors to the head;
placing a helmet on the head;
calibrating the plurality of sensors to determine calibration parameters relating to the sensitivities, positions and orientations of the plurality of sensors dependent upon measurements of the linear and rotational motion of the helmet and dependent upon signals from the plurality of sensors; and
determining the head motion dependent upon the calibration parameters of the plurality of sensors and dependent upon the signals from the plurality of sensors.

12. A system for monitoring motion of a body comprising:
a substantially rigid calibration structure;
a plurality of reference sensors attached to the substantially rigid calibration structure and responsive to motion of the substantially rigid calibration structure;
a communication port operable to receive signals from a plurality of body-mountable sensors;
a processing unit; operable to receive signals from the plurality of reference sensors and to receive, via the communication port, the signals from the plurality of body-mountable sensors,
wherein, in a first time interval, the processing unit is operable to determine the sensitivity of the plurality of body-mountable sensors to motion of the body, the sensitivity being dependent upon the signals from the plurality of reference sensors.

13. A system in accordance with claim 12, wherein the processor is further operable to determine the positions of plurality of body-mountable sensors relative to the substantially rigid calibration structure.

14. A system in accordance with claim 12, wherein, in a second time interval, the processor is operable to determine motion of the body dependent upon the signals from the plurality of body-mountable sensors.

15. A system in accordance with claim 12, further comprising the plurality of body-mountable sensors, the plurality of body-mountable sensors being operable to transmit signals to the communication port.

16. A system in accordance with claim 15, wherein the plurality of body-mountable sensors comprise at least six sensors, wherein at least three of six sensors are linear accelerometers.

17. A system in accordance with claim 16, wherein the plurality of body-mountable sensors further comprise at least one rotational sensor.

18. A system in accordance with claim 12, wherein the body comprises a head and wherein the substantially rigid calibration structure comprises a helmet.

19. A system in accordance with claim 12, wherein the processing unit, the plurality of reference sensors and the substantially rigid calibration structure comprise an electronics module adapted to couple to a helmet.

20. An apparatus for sensing motion parameters of a selected location in a substantially rigid body, the apparatus comprising:
a first plurality of motion sensors adapted to couple to the rigid body at positions displaced from the selected location and to produce a first plurality of sensed signals in response to motion of the substantially rigid body;
a memory operable to store calibration parameters that relate the sensed signals and motion of the substantially rigid body;
a processor operable to:
receive the sensed signals;
calculate each motion parameter dependent upon the calibration parameters and the first plurality of sensed signals, and
provide the motion parameters as output; and
an output port that communicates the motion parameters over an output channel,
wherein the calibration parameters are dependent upon the relative orientations of the sensing axes of the first plurality of motion sensors and the positions of the first plurality of motion sensors relative to the selected location.

21. An apparatus in accordance with claim 20, wherein the first plurality of motion sensors comprises three bi-axial accelerometers.

22. An apparatus in accordance with claim 20, wherein at least two of the first plurality of motion sensors are mounted on a common structure adapted to couple to the rigid body.

23. An apparatus in accordance with claim 22, wherein the substantially rigid body comprises a head and wherein the common structure comprises a nose band.

24. An apparatus in accordance with claim 22, wherein the substantially rigid body comprises a head and wherein the common structure comprises a head band.

25. An apparatus in accordance with claim 22, wherein the first plurality of motion sensors comprises three linear accelerometers and three rotational sensors mounted on a common structure, the common structure being adapted to couple to the rigid body.

26. An apparatus in accordance with claim 21, further comprising:
a second plurality of motion sensors mounted on a substantially rigid calibration structure and adapted to couple to the rigid body in one or more time periods to produce a second plurality of sensed signals; and
a processor, responsive to the first and second pluralities of sensed signals,
wherein the processor is operable to determine the calibration parameters that relate the sensed signals and motion of the substantially rigid body and store them in the memory.

27. An apparatus in accordance with claim 26, wherein the substantially rigid body comprises a human head and wherein the substantially rigid calibration structure comprises a helmet.
